(19) United States
(12) Patent Application Publication
(10) Pub. No.: US 2022/0343231 A1
(43) Pub. Date: Oct. 27, 2022

(54) TECHNIQUES FOR SCHEDULING AND EXECUTING PLANS FOR A USER OF AN INPUT/OUTPUT DEVICE

(71) Applicant: Intuition Robotics, Ltd, Ramat-Gan (IL)

(72) Inventors: Shay ZWEIG, Harel (IL); Alex KEAGEL, Tel Aviv (IL); Chen SORIAS, Kibbutz Zikim (IL); Dor SKULER, Oranit (IL)

(73) Assignee: Intuition Robotics, Ltd., Ramat-Gan (IL)

(21) Appl. No.: 17/660,696

(22) Filed: Apr. 26, 2022

Related U.S. Application Data
(60) Provisional application No. 63/179,775, filed on Apr. 26, 2021.

(51) Int. Cl. G06Q 10/06; G06Q 10/10; G06N 20/00; G06F 11/34; G06F 11/30

(52) U.S. Cl. CPC G06Q 10/0631; G06Q 10/1097; G06N 20/00; G06F 11/34; G06F 11/3041

(57) ABSTRACT

Techniques for executing plans for a user via an input/output (I/O) device is presented. The method includes determining plurality of transient plans based on user data captured by the I/O device and status report for at least one goal, wherein each of the plurality of transient plans is a customized plan for the user respect to the at least one goal; generating a plurality of customized schedules for the plurality of transient plans based on the user data and a policy for the user, wherein the policy includes a plurality of scheduling rules for determining the customized schedules and a plurality of rules for executing portions of the plurality of transient plans; and projecting at least one first plan of the plurality of transient plans via the I/O device based on the plurality of customized schedules and the plurality of rules for executing portions of the at least one plan.

### CROSS-REFERENCE TO RELATED APPLICATIONS

This application claims the benefit of U.S. Provisional Application No. 63/179,775, filed on Apr. 26, 2021, the contents of which are hereby incorporated by reference.

### TECHNICAL FIELD

The disclosure generally relates to digital assistants operated via input/output (I/O) devices, and more specifically to techniques for scheduling and executing plans for a user of an I/O device.

### BACKGROUND

As manufacturers improve the functionality of devices such as vehicles, computers, mobile phones, appliances, and the like, through the addition of digital features, manufacturers and end-users may desire enhanced device functionalities. The manufacturers, as well as the relevant end-users, may desire digital features which improve user experiences, interactions, and features which provide for greater connectivity. Certain manufacturers may include device-specific features, such as setup wizards and virtual assistants, to improve device utility and functionality. Further, certain software packages may be added to devices, either at the point of manufacture, or by a user after purchase, to improve device functionality. Such software packages may provide functionalities including, as examples, a computer system's voice control, facial recognition, biometric authentication, and the like.

While the features and functionalities described hereinabove provide for certain enhancements to a user's experience when interacting with a device, the same features and functionalities, as may be added to a device by a user or manufacturer, fail to include certain aspects which may allow for a further-enhanced user experience. First, certain currently-implemented digital assistants and other user experience features may fail to provide for adaptive adjustment of the operation of the assistant or feature. For example, a digital assistant configured to play music may be programmed to use a specific type of music streaming services, thereby limiting the user experience. In addition, certain currently-implemented digital assistants and other user experience features may fail to provide for adjustments of the assistant or feature operation based on context or environmental data. As an example, a digital assistant may be configured to present reminders to take vitamins at a certain time. However, such reminder may be inappropriate and disturbing when the user is surrounded by guests or at certain hours of the day.

Furthermore, certain currently-implemented digital assistants and other user experiences features may fail to provide for adjustments of the assistant or feature operation with respect to individual users. For example, a digital assistant may be configured to present a schedule reminder without any distinction between the user in the vicinity of the I/O device operating the digital assistant. It should be noted that even for the same operation, for example of a reminder to call someone, individual needs may be vastly different depending on, for example but not limited to, daily routine, schedule, habits, communication preferences, goals, and the like.

To this end, it is clear that adaptive adjustment of operation is particularly desired for assisting multiple users for effective assistance and operation. In the absence of such adaptiveness between each of the multiple users and their needs, the users may not benefit from policies or actions performed or suggested by the digital assistants, and eventually abandon the usage of such devices.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for executing plans via an input/output (I/O) device. The method comprises: determining a plurality of transient plans based on user data of a user captured by the I/O device and a status report for at least one goal, wherein each of the plurality of transient plans is a customized plan for the user with respect to the at least one goal, wherein the user data includes the at least one goal and user historical data; generating a plurality of customized schedules for the plurality of transient plans based on the user data and a policy for the user, wherein the policy includes a plurality of scheduling rules for determining the customized schedules based on the plurality of transient plans, wherein the policy further includes a plurality of rules for executing portions of the plurality of transient plans; and projecting at least one first transient plan of the plurality of transient plans via the I/O device, wherein the at least one first plan is projected via the I/O device based on the plurality of customized schedules and the plurality of rules for executing portions of the at least one plan, wherein a timing of projecting each of the at least one first plan is determined based on the plurality of customized schedules.

Certain embodiments disclosed herein also include a non-transitory computer readable medium having stored thereon causing a processing circuitry to execute a process, the process comprising: determining a plurality of transient plans based on user data of a user captured by the I/O device and a status report for at least one goal, wherein each of the plurality of transient plans is a customized plan for the user with respect to the at least one goal, wherein the user data includes the at least one goal and user historical data; generating a plurality of customized schedules for the plurality of transient plans based on the user data and a policy for the user, wherein the policy includes a plurality of scheduling rules for determining the customized schedules based on the plurality of transient plans, wherein the policy further includes a plurality of rules for executing portions of the plurality of transient plans; and projecting at least one first transient plan of the plurality of transient plans via the I/O device, wherein the at least one first plan is projected via the I/O device based on the plurality of customized schedules and the plurality of rules for executing portions of the at least one plan, wherein a timing of projecting each of the at least one first plan is determined based on the plurality of customized schedules.

Certain embodiments disclosed herein also include a system for executing plans via an input/output (I/O) device. The system comprises: an I/O device configured to capture user data and to output projections of transient plans; a processing circuitry; and a memory, the memory containing instructions that, when executed by the processing circuitry, configure the system to: determine a plurality of transient plans based on user data of a user captured by the I/O device and a status report for at least one goal, wherein each of the plurality of transient plans is a customized plan for the user with respect to the at least one goal, wherein the user data includes the at least one goal and user historical data; generate a plurality of customized schedules for the plurality of transient plans based on the user data and a policy for the user, wherein the policy includes a plurality of scheduling rules for determining the customized schedules based on the plurality of transient plans, wherein the policy further includes a plurality of rules for executing portions of the plurality of transient plans; and project at least one first transient plan of the plurality of transient plans via the I/O device, wherein the at least one first plan is projected via the I/O device based on the plurality of customized schedules and the plurality of rules for executing portions of the at least one plan, wherein a timing of projecting each of the at least one first plan is determined based on the plurality of customized schedules.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various embodiments of the disclosure.

FIG. 2 is a block diagram of a controller, according to an embodiment.

FIG. 3 is a flowchart illustrating a method for scheduling and executing plans for a user of a digital assistant according to an embodiment.

FIG. 4 is a flowchart illustrating a method for modifying a customized schedule based on feedback data according to an embodiment.

FIG. 5 is a flowchart illustrating a method for modifying a customized schedule based on feedback data received with respect to a presented customized schedule, according to an embodiment.

FIG. 6 is a flowchart illustrating a method for determining a current state of the user of the digital assistant for executing a transient plan according to an embodiment.

FIG. 7 is a flowchart illustrating a method for adjusting a customized schedule based on an indication received regarding a new goal according to an embodiment.

FIG. 8 is a flowchart illustrating a method for adjusting a customized schedule based on an updated state of at least the user, according to an embodiment.

### DETAILED DESCRIPTION

The embodiments disclosed by the disclosure are only examples of the many possible advantageous uses and implementations of the innovative teachings presented herein. In general, statements made in the specification of the present application do not necessarily limit any of the various claimed disclosures. Moreover, some statements may apply to some inventive features but not to others. In general, unless otherwise indicated, singular elements may be in plural and vice versa with no loss of generality. In the drawings, like numerals refer to like parts through several views.

The various embodiments disclosed herein provide techniques for effectively scheduling and executing plans for a user of a digital assistant by incorporating transient plans including actions to be performed via I/O devices into a plurality of customized schedules and dynamically adapting execution of the plans timed in accordance with the customized schedules. A transient plan is determined based on user data captured by the I/O device and a status report of a predefined goal to serve transient plans based on current status of the user with respect to the predefined goal. Moreover, a customized schedule is generated for the user of the digital assistant by incorporating individual user data and policy to execute user-specific transient plans at times tailored for the user. The policy of the user includes a plurality of scheduling rules for determining the customized schedule and a plurality of rules for executing the transient plans, which may be further modified from user sensory data captured at the input/output (I/O) device executing the digital assistant. Such generation of the plurality of customized schedules of the transient plans enable accurately and dynamically executing plans for users tailored to user-specific conditions (e.g., preference, pattern, habit, physical and emotional state, and so on) that can actively and rapidly change over time. A first plan projected based on the user-specific transient plan and customized schedule enables accurate and personalized serving of plans that better adhere to current status and state of the specific user to, in return, improve user receptiveness and interaction to the digital assistant towards meeting the predefined goal.

The disclosed embodiments include techniques for determining and utilizing transient plans and customized schedules. The transient plans are updated or otherwise modified over time, for example as the user progresses with respect to one or more goals. As the transient plans are updated, additional customized schedules are generated (i.e., new customized schedules may be generated or existing customized schedules may be updated) based on the updated transient plans and policies for the user, thereby further customizing the schedules as the transient plans change. Accordingly, the customized schedules are updated dynamically based on changes in circumstances reflected in the transient plans. In turn, these dynamically updated customized schedules are utilized to project, via an I/O device one or more of the transient plans at appropriate times and, moreover, to project appropriate updates to those plans at corresponding appropriate times. The disclosed embodiments therefore provide techniques for controlling an I/O device and, more specifically, to controlling timing of projections made via the I/O device.

The disclosed embodiments improve I/O devices utilized to execute these plans. In particular, user data captured as inputs via the I/O device is analyzed in order to determine transient plans to be used for creating customized schedules for users. The customized schedules are, in turn, utilized to time outputs projecting the plans created using these inputs. Thus, the disclosed embodiments provide improved control of I/O devices timing.

Moreover, the disclosed embodiments provide a rules-based process for generating customized schedules based on transient plans in order to time projections of such transient plans. The rules utilized in accordance with the disclosed embodiments allow for customizing schedules based on specific, objective factors and corresponding criteria in order to time projections accordingly in a manner which evolves over time, i.e., such that the timings of the projections change over the course of hours, days, weeks, months, and so on.

In this regard, it is noted that humans may make plans to be executed via I/O devices and set schedules accordingly, but that these schedules are not set or executed consistently because they are created and/or modified based on subjective opinions about what the plans “should” be and how they should accommodate changes in the users' activity and schedules. Even when an initial plan is created using objective criteria, updates to the plan are often made based on subjective evaluations of progress, and modifications to the schedule are further made based on subjective decisions regarding desirable times to reschedule. Consequently, any attempts to establish routines via I/O devices, which typically require consistency, either fail or are successful in spite of the operation of the I/O devices. Thus, the manual process for executing plans cannot be effectively automated.

The disclosed embodiments avoid this inconsistent execution of plans by utilizing objective rules for scheduling plans and by creating plans based on inputs to an I/O device rather than only based on subjective user intentions. The result is that plans are executed more by I/O devices in a manner that is consistent among different I/O devices.

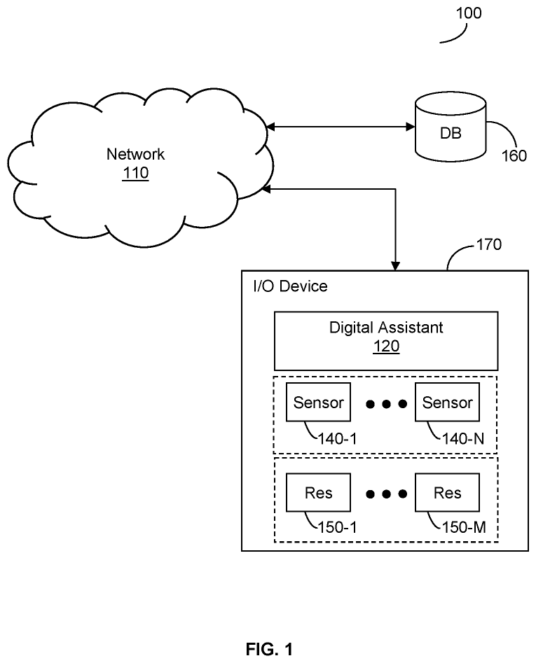

FIG. 1 is an example network diagram 100 utilized to describe the various disclosed embodiments. The network diagram 100 includes an input/output (I/O) device 170 operating a digital assistant 120. In some embodiments, the digital assistant 120 is further connected to a network 110 to allow some processing by a remote server (e.g., a cloud server, not shown). The network 110 may provide for communication between the elements shown in the network diagram 100. The network 110 may be, but is not limited to, a local area network (LAN), a wide area network (WAN), a metro area network (MAN), the Internet, a wireless, cellular, or wired network, and the like, and any combination thereof.

In an embodiment, the digital assistant 120 may be connected to, or implemented on, the I/O device 170. The I/O device 170 may be, for example and without limitation, a robot, a social robot, a service robot, a smart TV, a smartphone, a wearable device, a vehicle, a computer, a smart appliance, and the like.

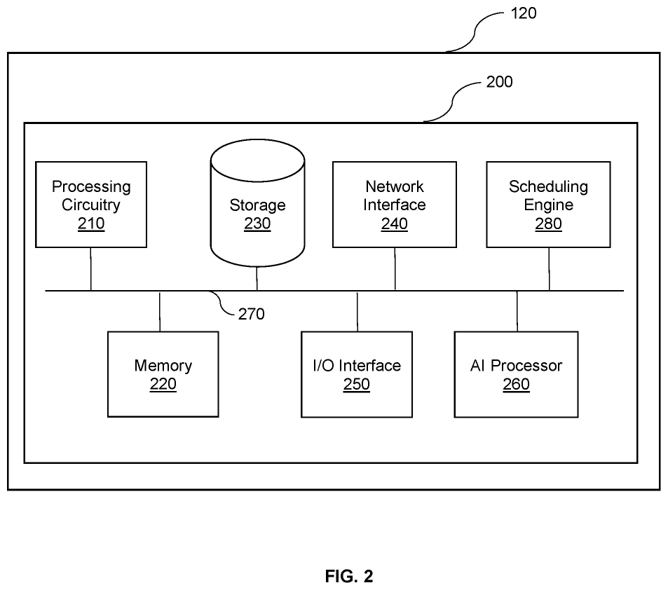

The digital assistant 120 may be realized in software, firmware, hardware, and any combination thereof. An example block diagram of a controller that may execute the processes of the digital assistant 120 is provided in FIG. 2. The digital assistant 120 is configured to process sensor data collected by one or more sensors, 140-1 to 140-N, where N is an integer equal to or greater than 1 (hereinafter referred to as “sensor” 140 or “sensors” 140 for simplicity) and to project plans or portions thereof via one or more output resources 150-1 to 150-M, where M is an integer equal to or greater than 1 (hereinafter referred to as “resource” 150 or “resources” 150 for simplicity). The outputs resources 150 may include, for example, electro-mechanical elements, display units, speakers, and the like. In an embodiment, the output resources 150 may include sensors 140 as well. The sensors 140 and the output resources 150 are included in the I/O device 170.

The sensors 140 may include input devices, such as various sensors, detectors, microphones, touch sensors, movement detectors, cameras, and the like. Any of the sensors 140 may be, but are not necessarily, communicatively, or otherwise connected to the digital assistant 120 (such connection is not illustrated in FIG. 1 for the sake of simplicity and without limitation on the disclosed embodiments). The sensors 140 may be configured to sense signals received from a user interacting with the I/O device 170 or the digital assistant 120, signals received from the environment surrounding the user, and the like. In an embodiment, the sensors 140 may be implemented as virtual sensors that receive inputs from online services, for example, the weather forecast, a user's calendar, and the like.

In an embodiment, a database (DB) 160 may be utilized. The database 160 may be part of the I/O device 170 (e.g., within a storage device, not shown), or may be separate from the I/O device 170 and connected thereto via the network 110. The database 160 may be utilized for storing, for example, health-related information of one or more users of the digital assistant, predefined health-related guidelines of the digital assistant, historical information of the user (e.g., patterns, preferences, and so on), and the like, as well as any combination thereof.

FIG. 2 is an example block diagram of a controller 200 acting as a hardware layer of a digital assistant 120, according to an embodiment. The controller 200 includes a processing circuitry 210 that is configured to receive data, analyze data, generate outputs, and the like, as further described hereinbelow. The processing circuitry 210 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The controller 200 further includes a memory 220. The memory 220 may contain therein instructions that, when executed by the processing circuitry 210, can cause the controller 200 to execute actions as further described hereinbelow. The memory 220 may further store therein information, for example but not limited to, data associated with one or more users, health-related information of one or more users, predetermined health parameters, values associated with the health parameters, historical information of the user (e.g., patterns, preferences, etc.), various feedback data (e.g., a user response, a user reaction, etc.), and the like.

The storage 230 may be magnetic storage, optical storage, and the like, and may be realized, for example, as a flash memory or other memory technology, or any other medium which can be used to store the desired information.

In an embodiment, the controller 200 includes a network interface 240 that is configured to connect to a network, e.g., the network 110 of FIG. 1. The network interface 240 may include, but is not limited to, a wired interface (e.g., an Ethernet port) or a wireless port (e.g., an 802.11 compliant Wi-Fi card), configured to connect to a network (not shown).

The controller 200 further includes an input/output (I/O) interface 250 configured to control the output resources (e.g., 150, FIG. 1) which are connected to the digital assistant 120. In an embodiment, the I/O interface 250 is configured to receive one or more signals captured by the sensors (e.g., 140, FIG. 1) of the digital assistant (e.g., 120, FIG. 1) and to send such signals to the processing circuitry 210 for analysis. In an embodiment, the I/O interface 250 is configured to analyze the signals captured by the sensors 140, detectors, and the like. In a further embodiment, the I/O interface 250 is configured to send one or more commands to one or more of the resources 150 for executing one or more plans including sets of actions to be performed via of the digital assistant 120, as further discussed herein below.

Executing a plan may include, but is not limited to, presenting or otherwise projecting a transient plan or a portion of the transient plan for the user based on a customized schedule created according to an embodiment. As an example, a plan may include suggesting the user to timely take her or his medications, play a cognitive game, suggesting the user to go out for a walk, reminding the user to go to yoga class, and so on. A plan is set of actions to be executed via an I/O device that is uniquely determined for a person such as the user of the digital assistant 120. In accordance with various disclosed embodiments, multiple plans are generated (e.g., as multiple different plans or updated versions of the same plan), where at least some of the generated plans are modified versions of respective previously generated plans, i.e., such that the plans collectively reflect changes over time are transient in nature.

To this end, in an embodiment, the plans are transient plan in which the plans change over time, either by generating a new version of an existing plan or generating an entirely new plan. Each transient plan, such as a recommendation or a suggestion, may be determined based on the unique plan based on goals, as well as respective achievement status reports for the goals for personalization for each of the users of the digital assistant 120. The transient plans may be periodically modified to better align and improve achievement of goals based on changes to the electronic achievement status reports and user data.

To this end, modifying the transient plans may include, but is not limited to, generating transient plans based on transient plan generation rules. The transient plan generation rules are applied to user activities and are defined with respect to milestones for such user activities. The transient plan generation rules define modifications to transient plans upon achieving such milestones. Accordingly, the transient plan generation rules provide objective rules for changing plans based on these milestones, which in turn results in modifications to plans which are consistent across users having comparable status reports relative to the same or like goals (e.g., goals in the same category).

In some configurations, the controller 200 may further include an artificial intelligence (AI) processor 260. The AI processor 260 may be realized as one or more hardware logic components and circuits, including graphics processing units (GPUs), tensor processing units (TPUs), neural processing units, vision processing units (VPU), reconfigurable field-programmable gate arrays (FPGA), and the like. The AI processor 260 is configured to perform, for example, machine learning based on sensory inputs received from the I/O interface 250, where the I/O interface 250 receives input data, such as sensory inputs, from the sensors 140.

In an embodiment, the components of the controller 200 are connected via a bus 270.

In an embodiment, the controller 200 may further include a scheduling engine 280. The scheduling engine 280 is configured to receive and analyze input data such as, but not limited to, a transient plan, user specific policy, and user data gathered with respect to the user in order to determine and generate a customized schedule for projecting at least a portion of a transient plan. In an embodiment, a transient plan is a set of actions (e.g., suggestion, recommendation, reminder, combinations thereof, and the like) to be executed via an I/O device that is customized to the user based on, among other things, the user's behavior, patterns, habits, preferences, and the like, as further discussed herein below. In an embodiment, the scheduling engine 280 may further be configured to present or communicate the customized schedule to the user, monitor the user response with respect to the customized schedule, adjust the customized schedule, and the like.

According to an embodiment, the controller 200, when executing the digital assistant 120, collects user data that is related to at least a user of the digital assistant 120. The user data may be collected through time using at least one sensor (e.g., the sensors 140) that may be connected to and controlled by the digital assistant 120. In an embodiment, the user data may be collected from one or more sources, such as, web sources, databases, social media, and the like. User data may include historical data of the user that may be indicative to the user's preferences, behavioral patterns, habits, and the like. In an embodiment, the user data may also include real-time data that is being collected in real-time with respect to the user and the user's environment in predefined proximity to the I/O device 170. That is, the user data may include sensory data that are analyzed using, for example, machine learning algorithm that is adapted to interpret the meaning of certain scenarios (e.g., user is alone, has company, asleep, angry, sad, happy, watching TV, and the like). Moreover, the user data may be interpreted to indicate user response (e.g., feedback) to the digital assistant 120. By collecting and analyzing sensory data that may be stored in a database (e.g., the database 160), user preferences, habits, behavioral patterns, and the like, may be determined. Thus, the user data may be indicative to, for example, but not limited to, the user's preferences, behavioral patterns, habit, and more.

For example, the collected user data may indicate that the user prefers doing physical activity at home when the temperature outside is below 59° F. As another example, the user data may indicate that the user has a daily meeting with friends at the park at 10:30 am, that the user usually sleeps between 2:00-3:30 pm, and the like. Also, as further discussed above, the user data may include real-time data about the user and the user's environment in a predetermined proximity to the I/O device executing the digital assistant. Thus, for example, the user data (i.e., user real-time data) may indicate whether the user is asleep or not, angry, relaxed, happy, sad, has company or not, the identity of the other person in the room, and the like.

According to one embodiment, the controller 200, when executing the digital assistant 120, retrieves an electronic achievement status report of a set of predefined goals of the digital assistant 120 and/or the user of the digital assistant 120. A goal is an objective that when achieved may improve, for example, the user-agent relationship, improve user's physical health, mental health, cognitive activity, social relationships, family bonds, and so on. For example, one of the goals may be related to physical health and the specific goal may be causing the user to perform five physical activities a day. The goals can be predefined based on the user's age, gender, current physical condition, current mental condition, and so on. In an embodiment, the setting of such goals may be performed by the user, a care giver, an authorized third party, an authorized operator, a company operating the digital assistant 120, and the like. A predefined goal of the digital assistant 120 may be, for example, to keep the user in a good shape (e.g., by suggesting doing physical activities), encourage the user to maintain her or his social relationships (e.g., by reminding meeting the friends at the park), and the like.

According to one embodiment, the set of predefined goals may be changed or modified through time based on the user's needs, preferences, restrictions, and so on. Thus, as one or more goals may be changed along the way, transient plans and customized schedules (that is further discussed herein below) may be respectively modified. It should be noted that the predefined goals may be updated occasionally, or periodically, for example, every day, every week, and so on. According to a second embodiment, the predefined goals may be changed based on a current state of the user and/or the environment near the user in proximity to the I/O device 170. For example, in case the user wakes up in the morning and feels bad, the predefined goals for the rest of the day may be automatically and respectively modified. In an embodiment, the current state of the user may be determined by applying at least one algorithm, such as a machine learning algorithm to the real-time or near real-time data of the user and/or user environment captured by the I/O device 170.

In an embodiment, the electronic achievement status report may be indicative of the fulfillment level of each goal of the predefined goals of the digital assistant 120. The fulfillment level may be, for example, a score from “1” to “5”, where “1” is the lowest score indicating that the fulfillment level of a certain goal is very low, and “5” is the highest score indicating that the specific goal has been achieved. It should be noted that as long as the highest fulfillment level of a specific goal has not been achieved yet, the objective of the digital assistant 120 is to improve the fulfillment level of the specific goal. Improving the fulfillment level of the goals may be achieved when the user performs activities of the transient plans that are projected by the digital assistant 120. The transient plans may include, but not limited to, reminding the user to go and meet her or his friends, encouraging the user to practice yoga, reminding the user to timely take her or his medications, and so on.

In an embodiment, the status report may be changed over time with the fulfillment (of unfulfillment) of the certain goal it is associated with. The status report may be changed based on user data collected by the I/O device 170. In another embodiment, the status report may be changed based on user data collected in response to a projected transient plan. As a non-limiting example, when the user did not perform any physical activity for more than 48 hours the fulfillment level of a physical health goal may be relatively low (e.g., “2” out of “5”). Thus, in order to improve the fulfillment level of the physical health goal, the digital assistant 120 may select to present a specific plan (or a transient plan) that includes encouraging the user to go out for a walk at the park.

According to an embodiment, the controller 200, when executing the digital assistant, is configured to determine a plurality of transient plans based on the collected user data and the electronic achievement status reports for predefined goals. The transient plan may include a set of actions for example, but not limited to, suggestions, recommendations, reminders, and the like, and any combination thereof, to be executed by the I/O device. In an embodiment, the transient plan for executing to a user may change according to different status reports and user data obtained by the I/O device to tailor to user's current status and predefined goals. Such modification of transient plans may include, but is not limited to, generating transient plans based on transient plan generation rules. It should be noted that generated transient plans may be or may include, for example, new versions of the existing plan, entirely new plans, both, or the like. As an example, a transient plan to meet a friend at the park may be changed to call a friend, or meet a group of friends, walk out to meet a friend, or the like.

According to one embodiment, the controller 200, when executing the digital assistant 120, analyzes the collected user data and a user policy to determine a plurality of customized schedules for executing one or more transient plans. The policy including a plurality of scheduling rules for creating the customized schedules and a plurality of rules for executing the determined transient plans based on the customized schedule are created for each user to objectively and accurately generate the customized schedules.

As further described herein, a transient plan may be designed to be executed by the digital assistant 120 in order to encourage or remind the user to perform activities, ask the user a question at a convenient and/or relevant time and collect a feedback, and so on. A customized schedule for a specific user may include a plurality of transient plans, that is user activities that should be performed, at specific or estimated time windows at which each transient plan should be performed. For example, the customized schedule may include user activities such as, but not limited to, taking medications at 7 am, do yoga at 7:30 am (e.g., since this is the user's favorite physical activity), go to the doctor at 10 am, call the user's grandchild anytime between 5 pm and 7 pm, and the like.

In an embodiment, the customized schedule is determined based on a plurality of rules for executing portions of the plurality of transient plans including at least rules for determining timings of projections of the transient plans or portions thereof. The plurality of rules for executing the transient plan (e.g., a suggestion to call a friend) may further include rules for enabling personalized approaches for example, but not limited to, a customized tone, atmosphere, resource, and the like. by which the transient plan (i.e., the suggestion) is projected to the user. The execution approach may be determined based on the collected user data that may include real-time data. Thus, a plan may be presented to a first user using a cynical tone, while the same plan may be presented to a second user using a more sensitive tone. It should be noted that, for example, even when a specific user generally likes a cynical approach, by collecting real-time data, the controller 200 may use a more sensitive approach.

In a further embodiment, the plurality of rules for executing portions of the plurality of transient plans may include rules for determining a customized intrusion level for a specific user. The intrusion level may include several modes such as silence, subtle, polite, intrusive and the like. The intrusion level may be determined based on, for example, sensory inputs that are collected and analyzed with respect to the user and the user's environment. For example, when a polite intrusion level is determined, the digital assistant 120 may present a certain plan to the user only after asking if it is okay to interrupt. As another example, when an intrusive level is selected, the digital assistant 120 may communicate with the user (e.g., present a certain transient plan to the user) even if the recent communication just ended and the user seems busy. As another example, a “follow up intrusive level” may also be used by the digital assistant 120 when the user approaches the digital assistant 120 in order to execute a certain plan. For example, the user may ask the digital assistant a question and since the “follow up intrusive level” is on, the digital assistant may generate an answer to the user's question and also execute a predetermined plan that was supposed to be executed only three hours later.

In an embodiment, the analysis of the collected user data and user policy may be achieved by applying at least one algorithm, such as a machine learning algorithm, (to the user data and the electronic achievement status report) that is adapted to determine the customized schedule for the user. For example, by analyzing the collected user data that indicates that the user usually does yoga three times a week and user policies including rules for scheduling and executing the transient plan to remind the user 30 min before the yoga class, at least a portion of the customized schedule to perform may be determined. According to the same example, the customized schedule may be a weekly schedule (i.e., a weekly program) that includes three yoga sessions a week, which may be updated thereafter as discussed further here within.

As noted above, the user policy includes a plurality of scheduling rules for determining the customized schedule by the controller 200. The plurality of scheduling rules may include restrictions and obligations that may be determined based on the user's electronic calendar (e.g., doctors' appointments, meetings, and the like), user's preferences, user's behavioral patterns, predefined spacing between plans, predefined capping, and so on. In an embodiment, the scheduling rules may give greater weight to some goals, obligations and restrictions and other goals, obligations and restrictions may get lower weights.

For example, although the social relationship status is relatively low (e.g., relative to a goal) and should be improved immediately, a doctor appointment should not be postponed in order to improve the fulfillment level of the social relationship goal. That is, the controller 200 (or the machine learning algorithm), executing the plurality of scheduling rules, may determine a greater weight to a doctor appointment compared to an achievement of a social relationship goal. Also, in case a plan that, for example, reminds the user to do something is already communicated to the user, the weight of such plan may be greater than a plan that was not yet communicated to the user.

According to a further embodiment, the controller 200, executing a digital assistant 120, may be configured to determine one or more sub-plans based on the user data and at least one of the plurality of transient plans. The sub-plans, to be executed by the I/O device 170, may be determined with respect to a specific transient plan to improve the compliance level of the user to executed transient plan (e.g., suggestions, recommendations, and the like). In an example embodiment, the sub-plan may be presented before the associated transient plan. In another example embodiment, the sub-plan may be executed after the associated transient plan.

The customized schedule may also be used for executing plans such as scheduling the presentation of questions for the user by the digital assistant 120, collecting user feedback, and the like. That is, by generating a customized schedule that includes upcoming plans (to be executed by the digital assistant 120) designed to, for example, encourage the user to complete the user activities, the compliance level of the user to plans executed by the digital assistant 120, may be improved. Thus, instead of suddenly suggesting the user to go out for a walk, the customized schedule may include the user's favorite physical activity (e.g., yoga) and used for preparing the user for the upcoming user activity by sharing the customized schedule with the user.

According to one embodiment, determining and generating the customized schedule may include determining an optimized schedule to be executed by the digital assistant 120. The optimized schedule may be one of the plurality of customized schedules generated. In an embodiment, the optimized schedule may be determined for one or more transient plans based on the abovementioned user data, user policies, including a plurality of scheduling and execution rules, as well as a predicted state of the user for further fine-tuning and control of execution timings. The predicted state of the user is an assumption of the user state at a certain time window. For example, the predicted user state on Sunday at 10 am, may indicate that the user will probably be calm and receptive, on Mondays between 2-4 pm the user usually sleeps, and the like.

In an embodiment, generating the customized schedule by the controller 200 and executing the digital assistant 120 may include three steps. The first step includes generation of a more general schedule, such as a weekly schedule, in which the different predefined goals are distributed across different days of the week and therefore daily goals are created for each day. The second step includes creating a high-level plan for each day including the daily goals and daily time windows at which plans, designed to facilitate achievement of the predefined goals, may be executed. The third step includes setting a specific plan on a specific time window. The time window may indicate a specific time (e.g., 7 pm) and it can also indicate a time frame (e.g., anytime between 5-8 pm). Thus, when a time frame is determined (and not a specific time) the digital assistant 120 may determine when exactly a plan shall be executed based on the current state.

It should be noted that the determined daily goals may be used by a decision-making model of the digital assistant 120 as guidelines for ad hoc decisions. A decision-making model of the digital assistant 120 may include one or more artificial intelligence (AI) algorithms that are utilized for determining the actions, plans, and the like, to be executed by the I/O device executing the digital assistant 120 considering, for example, the current state, user's preferences, patterns, and the like. For example, when the user suddenly appears at home (i.e., unexpected availability of the user) the decision-making model of the digital assistant 120 might execute (e.g., present) a plan that serves the daily goals even though the executed plan was not supposed to be executed at this time window, according to the customized schedule. According to the same example, in such case the customized schedule will be updated accordingly.

According to an embodiment, the controller 200, when executing the digital assistant 120, may be configured to constantly collect real-time data using the one or more sensors (e.g., the sensors 140) of the I/O device 170. In an embodiment, the controller 200 analyzes the real-time data by applying at least one algorithm, such as a machine learning algorithm, that may be stored in a memory (e.g., the memory 220). The algorithm may facilitate determination of at least a current state of at least the user based on the collected real-time data. In a further embodiment, the algorithm may facilitate determination of a current state of the environment near the user (e.g., in a predetermined proximity to the user) based on the real-time data. The current state may reflect the condition of the user and the user's environment in real-time or near real-time. The current state may indicate whether, for example, the user is sleeping, reading, stressed, angry, has company or not, and so on. The current state may further indicate the current time, weather, number of people in the room, people identity, and the like, and any combination thereof.

In further embodiment, the controller 200, when executing the digital assistant 120, is configured to modify and/or generate a customized schedule based on the determined current state of the user. In an embodiment, the customized schedule may be dynamically modified to change timing and/or approach with respect to execution of the transient plan. In another embodiment, a sub-plan or a brand new transient plan may be generated and scheduled base on the current state of the user.

As an example, according to the customized schedule, the user should start playing an online game with the user's grandchild within two minutes. However, the current state indicates that the user is sitting in the kitchen and not near the computer. According to the same example, the digital assistant executes a plan that may include a reminder for the user to turn on the computer and prepare for the online game. As another example, although the customized schedule determines that an encouraging notification to perform a scheduled workout should be presented to the user within one minute, the current state indicates that the user has company at home so the execution of the encouraging notification may be postponed. As another example, the user may not be near the digital assistant 120 (or not at home) and so a scheduled plan may be postponed. In an embodiment, the approach by which the plan is executed may be changed based on the determined current state.

In further embodiment, the plurality of customized schedules may be actively modified based on user data collected by the I/O device. The user data may include, but is not limited to, real-time data of the user and user's environment proximate to the I/O device, user calendar, websites, database, weather forecast, and the like, and any combination thereof, which may be utilized by the scheduling engine 280 for generation and modification of the plurality of customized schedules. For example, the original customized schedule may include a plan designed to remind the user to go out for a walk within 15 minutes, however real-time data indicates that current air pollution in the area is very high. According to the same example, the customized schedule may be modified respectively, postponing the walk outside in two hours.

According to an embodiment, the controller 200, when executing the digital assistant 120, may be configured to present at least one of the plurality of customized schedules to the user. Presenting the at least a one of the plurality of customized schedules to the user may be achieved using one or more resources (e.g., the resources 150) of the I/O device 170. The customized schedule may be presented to the user in order to, for example, improve the compliance level of the user to the scheduled user actions, reduce ambiguity with regard to the expected future plans, and the like.

In further embodiment, the controller 200 may be configured to collect feedback data from the user with respect to at least one of the presented customized schedule. The feedback data may include real-time data that may be captured using one or more sensors (e.g., the sensors 140) of the I/O device 170. The feedback data refers to the user reaction to the presented customized schedule. For example, the user may reject or accept the presented customized schedule or a portion thereof. The controller 200 may be configured to analyze the collected feedback data in order to determine the user's reaction with respect to the presented customized schedule. The analysis of the feedback data may be achieved using for example, computer vision techniques, audio signal processing techniques, machine learning techniques, and the like.

In another embodiment, the controller 200 may be configured to collect feedback data from the user with respect to the abovementioned executed at least one transient plan. That is, after a plan or portion of a plan is executed, feedback data may be collected. As noted above, the feedback data may include real-time data that may be collected using one or more sensors (e.g., the sensors 140). For example, the user may reject or accept one or more plans that were executed by the digital assistant 120. The controller 200 may be configured to analyze the collected feedback data in order to determine the user's reaction with respect to the executed plan. The analysis of the feedback data may be achieved using for example, computer vision techniques, audio signal processing techniques, machine learning techniques, and the like.

In an embodiment, the controller 200 may be configured to adjust the plurality of customized schedules based on the collected and analyzed feedback data. Adjusting the customized schedule may include, for example, rescheduling an upcoming plan, postponing the time at which a certain plan (e.g., a suggestion) will be executed, removing a certain plan from the customized schedule, and so on. It should be noted that the influence of the feedback data may cause a short-term adjustment of the customized schedule (e.g., of the next plan that should take place) as discussed above. However, the influence of the feedback data may also cause a long-term adjustment of more general definitions of the digital assistant 120. As an example for a long-term adjustment, the controller 200 may determine that in general, no plan is to be executed to the user before 10 am.

In an embodiment, the controller 200 may be configured to automatically update at least one of the plurality of customized schedules (i.e., automatic rescheduling) to reschedule execution of the transient plan without communicating it to the user. In another embodiment, the controller 200 may suggest the user several time slots for rescheduling, such that the user would be able to choose the one she or he prefers. In yet another embodiment, the controller 200 may be configured to generate a transient plan for rescheduling. As an example, a transient plan to execute a question asking the user for preferred time slots for rescheduling the customized schedule may be generate and projected to the user. Then, user data captured by the I/O device 170 may be utilized with the user policy to reschedule (i.e., generate customized schedule) the plan at the user's preferred time slot after validating no scheduling conflicts and the like according to the plurality of scheduling rules.

In another embodiment, the user may ask the digital assistant 120 for a specific time window to perform a certain task, or the user may ask to change at least part of the customized schedule. Thus, adjustment to the schedule may be made by the controller 200 which may be configured to accept the proposed time window, suggest new time window and verifying that the proposed time windows do not collide with other events in the schedule.

In an embodiment, the controller 200 may be configured to modify the plurality of customized schedules based on a compliance level of the user to the customized schedule. The compliance level of the user to the customized schedule may be determined based on the user's response to the executed transient plan according to the customized schedule. The user's response may include, for example but is not limited to, acceptance, rejection, no response, and the like, and any combination thereof. In an embodiment, the user's response may be determined based on analysis of the real-time data of the user captured through the I/O device when the transient plan is executed according to the customized schedule. The real-time data may be analyzed and therefore allows to determine the compliance level of the user to the customized schedule. As a non-limiting example, when the customized schedule includes suggesting the user to go out for a walk every Monday, Wednesday, and Friday at 6 am and the user rejected all of the suggestions, the customized schedule and/or the associated transient plan may be adjusted in order to improve the compliance level of the user.

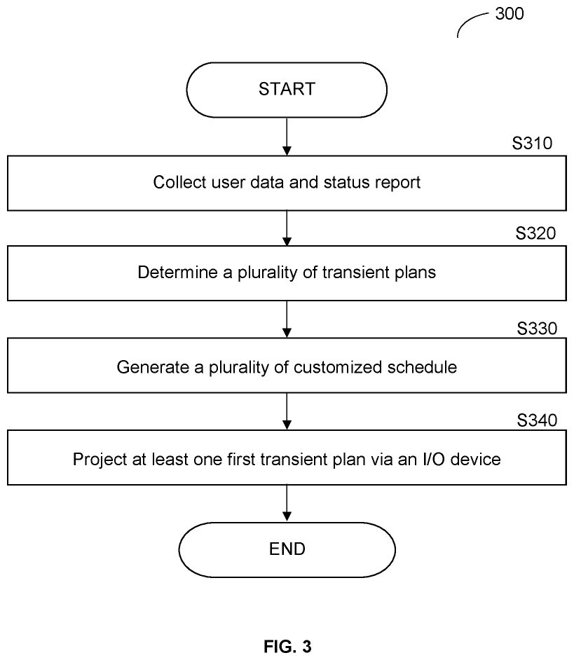

FIG. 3 shows an example flowchart 300 of a method for scheduling and executing plans for a user of a digital assistant according to an embodiment. The method described herein may be executed by the controller 200 executing the digital assistant 120 that is further described herein above with respect to FIG. 2.

At S310, user data and an electronic achievement status report of one or more predefined goals about a user of a digital assistant is collected. The user data may include historical data (including preferences, behavioral patterns, and the like) and at least one goal of the user. In an embodiment, the user data may also include real-time data that is being collected in real-time with respect to the user and the user's environment. The user data may be collected continuously or periodically using sensors (e.g., the sensors 140, FIG. 1) of the I/O device (e.g., the I/O device 170, FIG. 1) that are communicatively connected to and controlled by the digital assistant (e.g., the digital assistant 120, FIG. 1). The status report may be indicative of the fulfillment level of each goal of the predefined goals of the user. In another embodiment, the status report may indicate fulfillment level of each goal of the digital assistant (e.g., the digital assistant 120, FIG. 1).

A goal is an objective that when achieved can improve the user's physical health, mental health, cognitive activity, social relationships, family bonds, and so on. In an embodiment, a goal may relate to the needs of the digital assistant 120, such as, a goal of collecting missing or partial information about the user, nurture the relationship between the user and the digital assistant (e.g., the digital assistant 120, FIG. 1) and the like. For example, one of the goals may be related to physical health and the specific goal may be causing the user to perform five physical activities a day. The goals can be predefined based on the user's age, gender, current physical condition, current mental condition, and so on. In an embodiment, the setting of such goals may be performed by the user, a care giver, and the like.

At S320, a plurality of transient plans is determined based on the collected user data and the status report. The transient plans may be determined as further discussed herein above with respect to FIG. 2 to be executed by the I/O device. In an example embodiment, each transient plan may be, but is not limited to, a suggestion, a reminder, a recommendation, and the like, and any combination thereof. As noted above, multiple plans, at least some of which are updated versions of other plans or otherwise changed over time, are generated such that the plans are transient in nature.

At S330, a plurality of customized schedules may be generated for executing one or more of the transient plans, as further discussed herein above with respect of FIG. 2. The customized schedules are generated based on collected user data by applying user policies including a plurality of scheduling rules and a plurality of rules for executing portions of the plurality of transient plans. In an embodiment, the plurality of scheduling rules may define rules on, for example, restriction, obligations, and the like, and any combination thereof. A customized schedule may include plans that should be performed and the estimated time at which each plan or portion thereof should be performed by an I/O device (i.e., a device having I/O interfaces which allows for projecting the plans or portions thereof). In an embodiment, the customized schedule may include one or more plans designed to be executed by the digital assistant 120 in order to encourage, reminding, etc., the user to perform user activities. The generation of the plurality of customized schedules and associated policies are further described herein above with respect to FIG. 2.

At S340, at least one of the plurality of transient plans may be projected via an I/O device according to the generated customized schedule for the user. As noted above, the customized schedule may be determined based on one or more transient plans to be executed by the digital assistant and the estimated time at which each transient plan or portion thereof should be performed. As an example, the customized schedule may be a reminder to call a friend who celebrates her or his birthday today, take the user's medications right on time at 7 pm after dinner, and so on. In accordance with various disclosed embodiments, the plans are projected at timings determined based on the customized schedules.

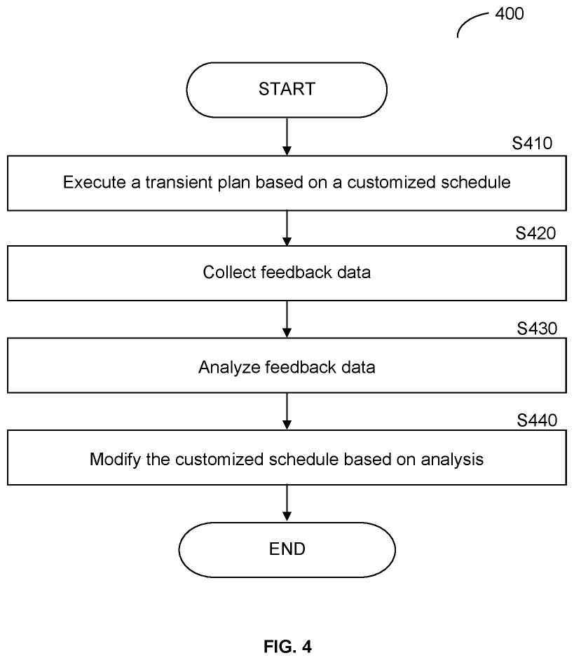

FIG. 4 shows an example flowchart 400 of a method for modifying a customized schedule based on feedback data received with respect to an executed transient plan, according to an embodiment. The method described herein may be executed by the controller 200 executing the digital assistant 120 that is further described herein above with respect to FIG. 2.

At S410, a transient plan is executed based on the customized schedule via an I/O device (e.g., the I/O device 170, FIG. 1). The transient plan may include a set of actions to be performed via the I/O device such that executing the transient plan may include, for example, reminding the user about an upcoming event, such as, a meeting with a friend.

At S420, a feedback data is collected from the user with respect to the executed plan. The feedback data may refer to the user reaction to the executed plan. For example, the user may reject or accept the executed first plan. The feedback data may include real-time data that may be collected using one or more sensors (e.g., the sensors 140) of the I/O device.

At S430, the collected feedback data is analyzed. The analysis of the feedback data may be achieved using one or more computer vision techniques, audio signal processing techniques, machine learning techniques, and the like. As a non-limiting example, the analysis may be achieved by applying one or more trained machine learning models which identify the user's response in real-time, or near real-time, whether it is a vocal response, a gesture, a facial expression, and so on. For example, when the user tilts her or his head up and down, a trained machine learning model may interpret this kind of gesture as indication that the user accepts the plan (e.g., reminder, suggestion, and so on) executed by the I/O device. As another example, when the user says “this is great, thanks for reminding me” after a reminder to start an online yoga class is executed, a trained machine learning model may interpret this kind of gesture as indication that the user accepts the reminder.

At S440, the customized schedule is modified based on the collected and analyzed feedback data. Adjusting the customized schedule may include for example, postponing the time at which a future plan (e.g., a suggestion) will be executed (e.g., presented to the user), removing a scheduled plan from the customized schedule, and so on.

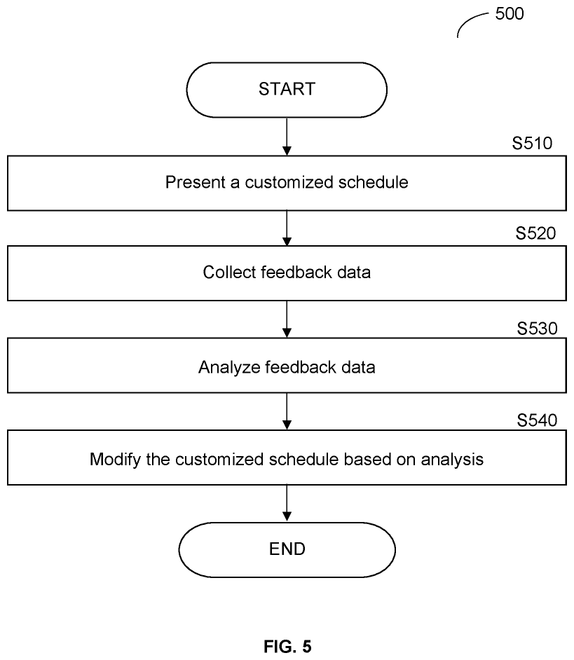

FIG. 5 shows an example flowchart 500 of a method for modifying a customized schedule based on feedback data with respect to a presented customized schedule, according to an embodiment. The method described herein may be executed by the controller 200 executing the digital assistant 120 that is further described herein above with respect to FIG. 2.

At S510, a customized schedule is presented to the user. The customized schedule is at least one of the plurality of customized schedules generated for the specific user of the digital assistant. In an embodiment, the customized schedule may be utilized for encouraging the user of the digital assistant to perform and complete user activities that may be determined based on predetermined goals of the digital assistant and/or the user of the digital assistant. Such user activities may include for example, perform a home workout, call a friend, timely take medications, play a cognitive game, and so on. The customized schedule may also include, for example, an estimated convenient time for asking the user a question (i.e., by the digital assistant 120 executed by the I/O device 170, FIG. 1) and collect feedback from the user.

At S520, a feedback data is collected from the user with respect to the presented customized schedule. The feedback data refers to the reaction of the user with respect to the presented customized schedule. For example, the user may reject or accept the customized schedule. The feedback data may include real-time data that may be collected using one or more sensors (e.g., the sensors 140, FIG. 1).

At S530, the collected feedback data is analyzed. The analysis of the feedback data may be achieved using one or more computer vision techniques, audio signal processing techniques, machine learning techniques, and the like. As a non-limiting example, the analysis may be achieved by applying one or more trained machine learning models which identify the user's response in real-time, or near real-time, whether it is a vocal response, a gesture, a facial expression, and so on. For example, when the user tilts her or his head up and down, a trained machine learning model may interpret this kind of gesture as indication that the user accepts the presented customized schedule (or a portion thereof that was just presented to the user).

At S540, the customized schedule is modified based on the collected and analyzed feedback data. Modification of the customized schedule may include for example, postponing a scheduled user activity, postpone the time at which a certain plan (e.g., a suggestion) will be executed (e.g., presented to the user), removing a user activity from the customized schedule, and so on.

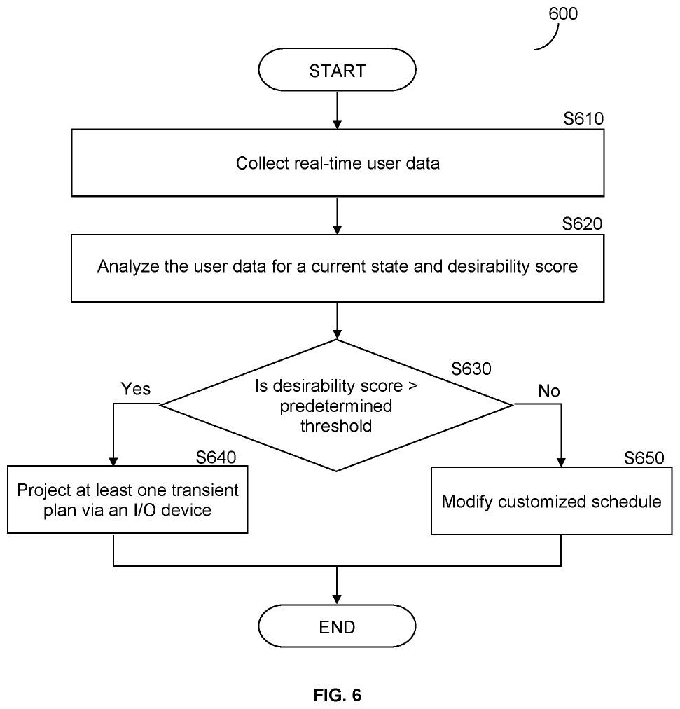

FIG. 6 shows an example flowchart 600 of a method for determining a current state of the user of the digital assistant for executing a transient plan according to an embodiment. The method described herein may be executed by the controller 200 executing the digital assistant 120 that is further described herein above with respect to FIG. 2. The method of FIG. 6 may be utilized by a device having I/O capabilities to objectively determine the potential need for modifying or otherwise updating a schedule used for executing plans by the device.

At S610, real-time data about at least a user of the digital assistant is constantly or periodically collected using the one or more sensors (e.g., the sensors 140) of an I/O device. In an embodiment, a controller (e.g., the controller 200, FIG. 2) analyzes the real-time data. The analysis may be achieved using at least one algorithm, such as a machine learning algorithm, that may be stored in a memory (e.g., the memory 220, FIG. 2). The algorithm may facilitate determination of at least a current state of at least the user based on the collected real-time data. In a further embodiment, the algorithm may facilitate determination of a current state of the environment near the user (e.g., in a predetermined proximity to the user) based on the real-time data.

At S620, the current state of the user and the current desirability score are determined. The analysis for determining may be achieved using at least one algorithm, such as a machine learning algorithm, that may be stored in a memory (e.g., the memory 220, FIG. 2). The algorithm may facilitate determination of at least a current state of the user based on at least portion of the user data. In a further embodiment, the algorithm may facilitate determination of a current state of the environment near the user (e.g., in a predetermined proximity to the user) based on at least a portion of the collected dataset of the user.

The current state may reflect the condition of the user and the condition of the environment near the user in real-time, or near real-time. The current state may indicate whether, for example, the user is sleeping, reading, stressed, angry, has company or not, and so on. The current state may further indicate the current time, weather, number of people in the room, people identity, and the like, and any combination thereof. In a further embodiment, the collected set of data may be analyzed using, for example and without limitations, one or more computer vision techniques, audio signal processing techniques, machine learning techniques, and the like.

In addition to the current state, the desirability score is determined to objectively identify the appropriate timing for projecting at least a first plan of the transient plan. The desirability score may indicate the degree of appropriateness with respect to factors such as, but not limited to, current time, people around the user, location of user, combinations thereof, and the like.

At S630, a check is performed whether a desirability score is greater than a predetermined threshold. If so, execution continues with S640; otherwise, execution continues with S650. At S640, at least one first transient plan is projected via an I/O device. In an embodiment, the at least one first transient plan is executed based on a previously created customized schedule. At S650, the customized schedule is modified. In an embodiment, the at least one first transient plan may be executed thereafter according to the modified customized schedule (e.g., of S650).

As an example, the current state may indicate that the user is sleeping and according to the customized schedule the user was supposed to participate in an online yoga class, the customized schedule may be modified such that the online yoga class will be rescheduled for the next day.

It should be noted that the plurality of transient plans of the customized schedule generated by the digital assistant (e.g., the digital assistant 120, FIG. 1) may include suggesting the user to timely take her or his medications, play a cognitive game, suggesting the user to go out for a walk, reminding the user to go to yoga class, and so on. As noted above, an executed plan may include a customized tone, atmosphere, approach, and the like. by which the plan is presented to the user, which may be determined based on the collected user data that may include real-time data. Thus, a certain plan may be presented to a first user using a cynical tone, while the same plan may be presented to a second user using a more sensitive tone. It should be noted that, for example, even when a specific user generally likes a cynical approach, by collecting and analyzing real-time data, the digital assistant 120 may be configured to modify the customized schedule to take, for example, a more sensitive approach.

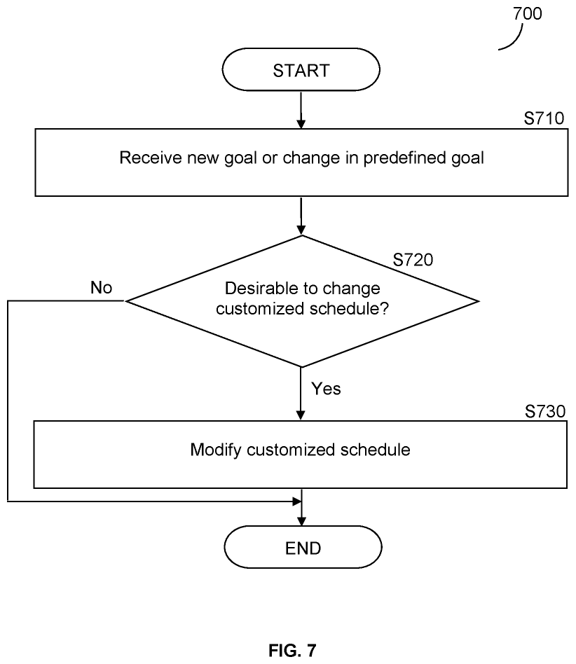

FIG. 7 shows an example flowchart 700 of a method for adjusting a customized schedule based on an indication received regarding a new or modified goal of the digital assistant according to an embodiment. The method described herein may be executed by the controller 200 executing the digital assistant 120 that is further described herein above with respect to FIG. 2.

At S710, an indication regarding a new goal of a digital assistant (e.g., the digital assistant 120, FIG. 1) and/or the user is received. The new goal may be a change to at least one predefined goal that was previously received. It should be noted that goals may be added, changed or modified through time based on the user's needs, preferences, restrictions, and so on. In an embodiment, a new goal may be created and added to a set predefined goals by an authorized entity (e.g., authorized server, user device, and the like) that is configured to communicate such goals to the digital assistant. It should be noted that S710 may further include storing the new goal(s) or the changes associated with the predetermined goals, in a memory, database, and the like.

At S720, it is checked whether it is desirable to change a customized schedule with respect to the new and/or modified goal(s) and if so, execution continues with S730; otherwise, execution ends.

At S730, the customized schedule is modified based on the new/modified goal(s). Adjusting the customized schedule may include, for example, change the predetermined order of the upcoming plans, remove a certain plan from the customized schedule, and so on.

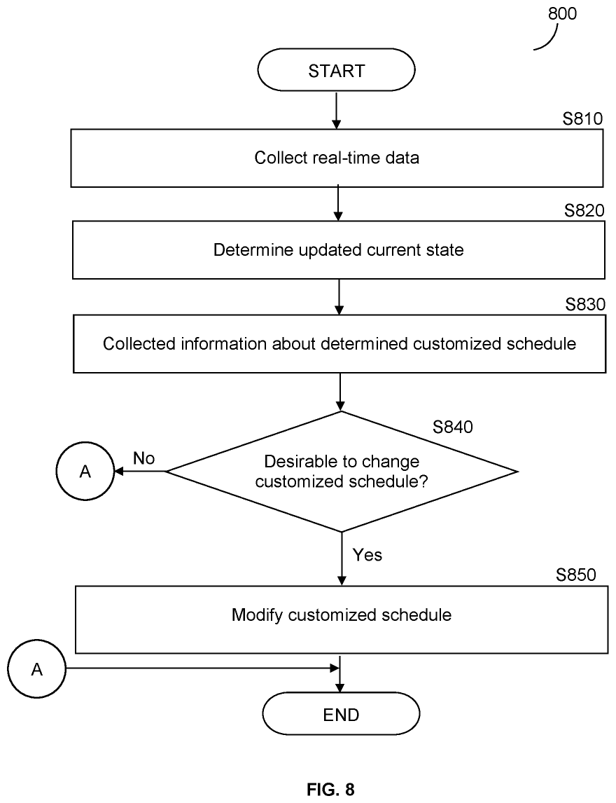

FIG. 8 shows an example flowchart 800 of a method for adjusting a customized schedule based on an updated state of at least the user, according to an embodiment. The method described herein may be executed by the controller 200 executing the digital assistant 120 that is further described herein above with respect to FIG. 2.

At S810, real-time data about at least a user of the digital assistant is constantly or periodically collected using the one or more sensors (e.g., the sensors 140). In an embodiment, the controller 200 analyzes the real-time data using at least one algorithm, such as a machine learning algorithm, that may be stored in a memory (e.g., the memory 220). The algorithm may facilitate determination of at least a current state of at least the user based on the collected real-time data. In a further embodiment, the algorithm may facilitate determination of a current state of the environment near the user (e.g., in a predetermined proximity to the user) based on the real-time data.

At S820, an updated current state of the user and the user environment is determined based on analysis of the real-time data. The updated current state may reflect the condition of the user and the condition of the environment near the user in real-time, or near real-time. The current state may indicate whether, for example, the user is sleeping, reading, stressed, angry, has company or not, and so on. The current state may further indicate the current time, weather, number of people in the room, people identity, and the like, and any combination thereof.

At S830, information about a customized schedule that was determined with respect to the user is collected. The information may include the plurality of transient plans to be executed according to the customized schedule including, but not limited to, the number of plans, the time windows at which each plan should be executed, the goals that should be fulfilled by the executed plans, and so on.

At S840, based on the updated current state of at least the user and the collected information about the customized schedule (that was determined for the user), it is determined whether it is desirable to change the customized schedule and if so, execution continues with S850; otherwise, execution ends. Determining whether it is desirable to adjust the customized schedule may be achieved by analyzing data features of the updated current state and the collected information about the determined customized schedule. The analysis may be achieved using, for example, a set of rules. For example, a rule may indicate that when the user is angry no plans should be suggested to the user. According to the same example, the customized schedule (i.e., that was previously determined) may be adjusted respectively and therefore prevent an upcoming plan (e.g., that would remind the user to join an on-line yoga class) from being executed.

It should be noted that a change in the current state of the user and/or the environment near the user, may invoke a change in the predetermined goals, a plurality of scheduling rules (e.g., required spacing between executed plans, capping of plans for execution in a time frame), availability predictions of the user (e.g., predicted state of user), and so on. For example, the updated current state indicates that the user came back home surprisingly, complaining that she or he is not feeling that good. According to the same example, the predetermined customized schedule includes several plans for the rest of the day which require the user to be active. Therefore, it may be desirable to generate at least one new goal or modify an existing goal(s) such that the new/modified goals would suit the current state.

At S850, the customized schedule is adjusted based on the new/modified goal(s). Adjusting the customized schedule may include for example, change the predetermined order of the upcoming plans, add a new plan, remove a certain plan from the customized schedule, and so on. It should be noted that modification of goals can not only cause modification of customized schedules, but also result in generation of new versions and/or entirely new transient plans that are executed to achieve the predefined goals. To this end, a plurality of versions of customized schedules may be generated to execute the plurality of transient plans with respect to the new goal.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for executing plans via an input/output (I/O) device, comprising:
determining a plurality of transient plans based on user data of a user captured by the I/O device and a status report for at least one goal, wherein each of the plurality of transient plans is a customized plan for the user with respect to the at least one goal, wherein the user data includes the at least one goal and user historical data;
generating a plurality of customized schedules for the plurality of transient plans based on the user data and a policy for the user, wherein the policy includes a plurality of scheduling rules for determining the customized schedules based on the plurality of transient plans, wherein the policy further includes a plurality of rules for executing portions of the plurality of transient plans; and
projecting at least one first transient plan of the plurality of transient plans via the I/O device, wherein the at least one first plan is projected via the I/O device based on the plurality of customized schedules and the plurality of rules for executing portions of the at least one plan, wherein a timing of projecting each of the at least one first plan is determined based on the plurality of customized schedules.

2. The method of claim 1, wherein determining the plurality of transient plans further comprises:
repeatedly generating plans of the plurality of transient plans based on changes to the status report, wherein the status report is changed based on the user data captured by the I/O device in response to the projected at least one first transient plan.

3. The method of claim 1, further comprising:
applying a machine learning model trained to determine a current state of the user based on a real-time user data and a real-time environmental data in a proximity to the user, wherein the real-time user data and the real-time environmental data are captured by at least one sensor of the I/O device; and
modifying the plurality of customized schedules based on the determined current state.

4. The method of claim 1, further comprising:
projecting at least one of the plurality of customized schedules via the I/O device;
storing a response by the user to the projected at least one of the plurality of customized schedules as a feedback data in a memory, wherein the feedback data is part of the user data captured from the I/O device; and
updating the at least one of the plurality of customized schedules based on the stored feedback data.

5. The method of claim 1, wherein generating the plurality of customized schedules further comprises:
determining a predicted state of the user with respect to at least a portion of the plurality of transient plans based on the user data;
creating, based on the determined predicted state, at least one rule of the plurality of scheduling rules for determining an optimized customized schedule.

6. The method of claim 1, further comprising:
generating a sub-plan based on the user data and the at least one transient plan; and
determining at least one rule for executing the sub-plan, wherein a timing for executing the sub-plan is before the plurality of transient plans.

7. The method of claim 1, wherein the user data is captured by the I/O device at least one of: continuously and periodically.

8. The method of claim 1, wherein the at least one goal is initially predefined and subsequently updated periodically.

9. A non-transitory computer readable medium having stored thereon instructions for causing a processing circuitry to execute a process, the process comprising:
determining a plurality of transient plans based on user data of a user captured by the I/O device and a status report for at least one goal, wherein each of the plurality of transient plans is a customized plan for the user with respect to the at least one goal, wherein the user data includes the at least one goal and user historical data;
generating a plurality of customized schedules for the plurality of transient plans based on the user data and a policy for the user, wherein the policy includes a plurality of scheduling rules for determining the customized schedules based on the plurality of transient plans, wherein the policy further includes a plurality of rules for executing portions of the plurality of transient plans; and
projecting at least one first transient plan of the plurality of transient plans via the I/O device, wherein the at least one first plan is projected via the I/O device based on the plurality of customized schedules and the plurality of rules for executing portions of the at least one plan, wherein a timing of projecting each of the at least one first plan is determined based on the plurality of customized schedules.

10. A system for executing plans via an input/output (I/O) device, comprising:
an I/O device configured to capture user data and to output projections of transient plans;
a processing circuitry; and
a memory, the memory containing instructions that, when executed by the processing circuitry, configure the system to:
determine a plurality of transient plans based on user data of a user captured by the I/O device and a status report for at least one goal, wherein each of the plurality of transient plans is a customized plan for the user with respect to the at least one goal, wherein the user data includes the at least one goal and user historical data;
generate a plurality of customized schedules for the plurality of transient plans based on the user data and a policy for the user, wherein the policy includes a plurality of scheduling rules for determining the customized schedules based on the plurality of transient plans, wherein the policy further includes a plurality of rules for executing portions of the plurality of transient plans; and
project at least one first transient plan of the plurality of transient plans via the I/O device, wherein the at least one first plan is projected via the I/O device based on the plurality of customized schedules and the plurality of rules for executing portions of the at least one plan, wherein a timing of projecting each of the at least one first plan is determined based on the plurality of customized schedules.

11. The system of claim 10, wherein the system is further configured to:
repeatedly generate plans of the plurality of transient plans based on changes to the status report, wherein the status report is changed based on the user data captured by the I/O device in response to the projected at least one first transient plan.

12. The system of claim 10, wherein the system is further configured to:
apply a machine learning model trained to determine a current state of the user based on a real-time user data and a real-time environment data in a proximity to the user, wherein the real-time user data and the real-time environmental data are captured by at least one sensor of the I/O device; and
modify the plurality of customized schedules based on the determined current state.

13. The system of claim 10, wherein the system is further configured to:
project at least one of the plurality of customized schedules via the I/O device;
store a response by the user to the projected at least one of the plurality of customized schedules as a feedback data in a memory, wherein the feedback data is part of the user data captured from the I/O device; and
update the at least one of the plurality of customized schedules based on the stored feedback data.

14. The system of claim 10, wherein the system is further configured to:
determine a predicted state of the user with respect to at least a portion of the plurality of transient plans based on the user data;
create, based on the determined predicted state, at least one rule of the plurality of scheduling rules for determining an optimized customized schedule.

15. The system of claim 10, wherein the system is further configured to:
generate a sub-plan based on the user data and the at least one transient plan; and
determine at least one rule for executing the sub-plan, wherein a timing for executing the sub-plan is before the plurality of transient plans.

16. The system of claim 10, wherein the user data is captured by the I/O device at least one of: continuously and periodically.

17. The system of claim 10, wherein the at least one goal is initially predefined and subsequently updated periodically.
